(19) United States
(12) Patent Application Publication
(10) Pub. No.: US 2007/0211886 A1
(43) Pub. Date: Sep. 13, 2007

(54) Phone converter system

(76) Inventors: Thomas H. Adams, San Antonio, TX (US); Yolius Diroo, San Antonio, TX (US); Michael Raftelis, San Antonio, TX (US); Craig Schreader, San Antonio, TX (US)

Correspondence Address: BRINKS HOFER GILSON & LIONE, P.O. BOX 10395, CHICAGO, IL, 60610, US

(21) Appl. No.: 11/372,359

(22) Filed: Mar. 9, 2006

(51) Int. Cl. H04M 1/00; H04M 9/00

(52) U.S. Cl. 379/413.03

(57) ABSTRACT

A phone converter system may allow a phone customer to keep a standard phone where the dial tone is maintained even when power is lost in the home. The phone converter system is maintained in the phone company's network, and not in the user's home. The phone converter system includes a local telephone provider with a power output from an SAI of IDF to a user telephone, a phone converter device to supply power and phone services to the user telephone, and an interface between the phone converter and network equipment. Utilizing the phone converter system may eliminate the use of battery backup in the customer's home.

### BACKGROUND OF THE INVENTION

1. Technical Field

This invention relates to telecommunications service for remote systems. In particular, this invention relates to a phone converter device for remote systems service.

2. Related Art

Devices exist that convert traditional phones so they can be used in the home as a voice-over-internet-protocol (VoIP) phone. When the power is lost in the home, and the user does not have Plain Old Telephone Service (POTS), the phone fails to work without a battery backup system inside the home. The battery backup requires floor space, is very expensive, and there may be environmental issues from possible battery spills. Additionally, battery backup is a major inconvenience to the phone customer. Therefore, a need exists for a system to deliver power to customers without a battery backup system.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 illustrates an example telephone network system with a phone converter.

FIG. 2 illustrates an example phone converter.

FIG. 3 illustrates a second example phone converter.

FIG. 4 illustrates a fourth example phone converter.

FIG. 5 illustrates an example line card with a phone converter.

FIG. 6 illustrates an example telephone network system with a phone converter in a supply module.

FIG. 7 illustrates an example telephone network with a phone converter in a central office.

### DETAILED DESCRIPTION OF THE PREFERRED EMBODIMENTS

A phone converter system includes a local telephone provider with a power output from a call termination module to a user telephone, a phone converter device to supply power and phone services to the user telephone, and an interface between the phone converter and network equipment. Utilizing the phone converter system may eliminate the use of battery backup in the customer's home.

The phone converter system provides a device for supplying power to a telephone system including a phone converter located in a local telephone support unit, a power line output connected to the phone converter, a power line output connected with a remote telephone system, and an interface for termination to network equipment. The phone converter is configured to interface with a patch panel located at a phone services distribution unit.

A phone converter system may allow a phone customer to keep a standard phone where the dial tone is maintained even when power is lost in the home. The phone converter system is maintained in the phone company's network, and not in the user's home. Utilizing the phone converter system may eliminate the use of battery backup in the customer's home.

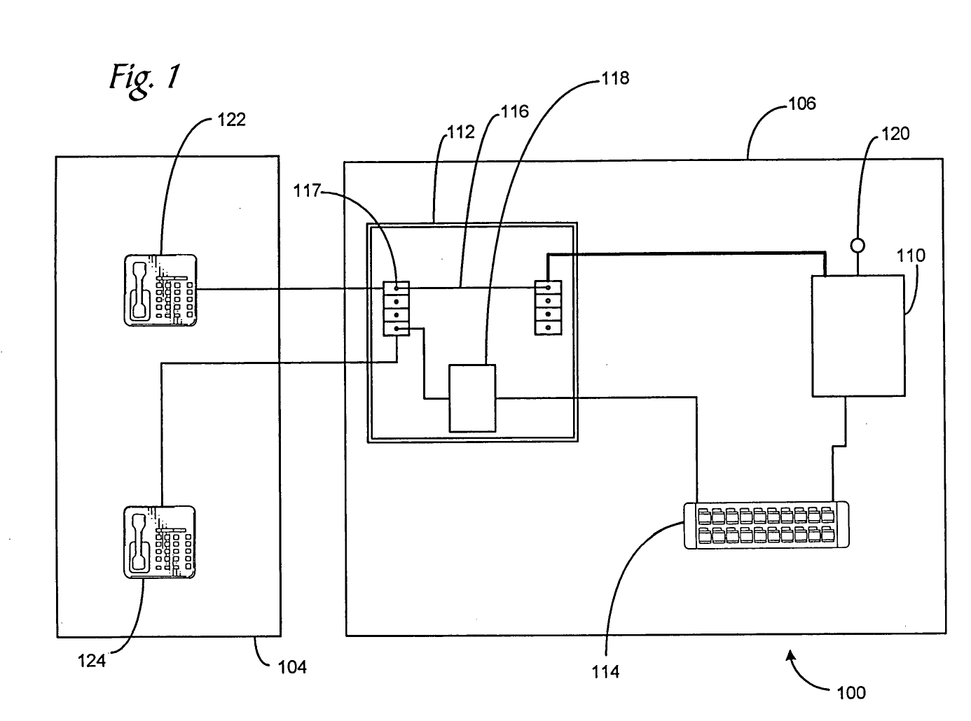

FIG. 1 illustrates an example telephone network 100 including a phone converter device. The network 100 includes a remote customer telephone system 104 and a local telephone support unit, such as a local telephone company system 106. The telephone company system 106 may provide analog or digital phone services, such as plain old telephone service (POTS) or voice-over-internet-protocol (VoIP) services. The telephone company system includes a supply module 112 configurable to supply a power line output in communication with a remote customer telephone system 104 which may supply a dial tone and/or power to the remote customer telephone system 104. The supply module 112 may include an Intermediate Distribution Frame (IDF) or a Serving Area Interface (SAI). An IDF is located in a central office or customer premises, and includes a frame that (a) cross-connects the user cable media to individual user line circuits and (b) may serve as a distribution point for multipair cables from the main distribution frame (MDF) or combined distribution frame (CDF) to individual cables connected to equipment in areas remote from these frames. The SAI, also known as a B-Box, cross-connect box, or Access Point (AP) is an outdoor telecommunications cabinet usually mounted on the ground on cable right-of-ways but can also be located on poles. Individual twisted pairs of a telephone local loop may be terminated at the SAI, at a patch panel 117. Individual twisted pair wires interface with F2 cable pairs and connect with F1 pairs at the SAI, such as through patch panels 117 via RJ11 connection jacks 116. Fl or main feeder cables then go underground in conduit or along poles, usually to the nearest central office (CO) or remote switch, or first to transmission equipment like a multiplexer and then to the CO.

The supply module 112 is connected to local network equipment 114 supporting a group of homes, through a first interface for termination to the local network equipment 114. The local network equipment 114 may include network equipment to supply analog or digital network services, such as digital subscriber link (DSL), VoIP, cable television services, or other data packet services. The supply module 112 and the network equipment 114 are connected to a common carrier switching center in which trunks and loops are terminated and switched, such as a power line output in communication with the phone converter 118, or a central office (CO) 110. The CO is interfaced to a source of power 120, which may include alternating current (AC) sources such as a commercial power grid or local power generator, or direct current (DC) sources such as a battery source.

A phone converter 118 is positionable in the supply module 112, in the IDF or in the SAI, or in the CO 110. The phone converter 118 is configured to interface with a patch panel 117 located at the phone services distribution unit, such as the local telephone company system 106. The phone converter 118 may include a second interface configured to terminate to the patch panel 117. The second interface may be implemented as an RJ-45 jack in one example embodiment. The local phone company system 106 supplying dial tone will also provide the power to the phone converter 118. The user may utilize traditional phone with VoIP service even during a power outage. The phone converter also provides a method of upgrading a tradition Time Division Multiplexer (TDM) phone user to VoIP type service without replacing any of the user's phones or adding any additional power sources, such as a device for connecting analog telephones to a Voice over IP system or Analog Telephony Adapter (ATA) and/or a battery.

The remote customer telephone system 104 includes customers receiving POTS 112 or customers 124 receiving POTS with VoIP or other services or customers receiving only VoIP or other services. Customers 124 may receive DSL, cable television, Internet, or other integrated telecommuncations services.

The phone converter 118 may be implemented as a module to convert POTS to VoIP or network services, or other communication links. The phone converter 118 may be implemented as integrated circuit such as an application specific integrated circuit (ASIC), microprocessor, microcontroller, digital signal processor (DSP), network computer, network appliance, or other integrated circuit. The phone converter 118 may be implemented as software or other computer readable code embodied in a computer readable means such as a memory. Examples of memory include hard disk drives, non-volatile memory such as read only memory (ROM), electrically eraseable programmable read only memories (EEPROMs), volatile memory such as dynamic random access memory (DRAMs), flash memory, removable media such as compact discs (CDs) or digital versatile discs (DVDs), floppy disks, or other memory storage devices.

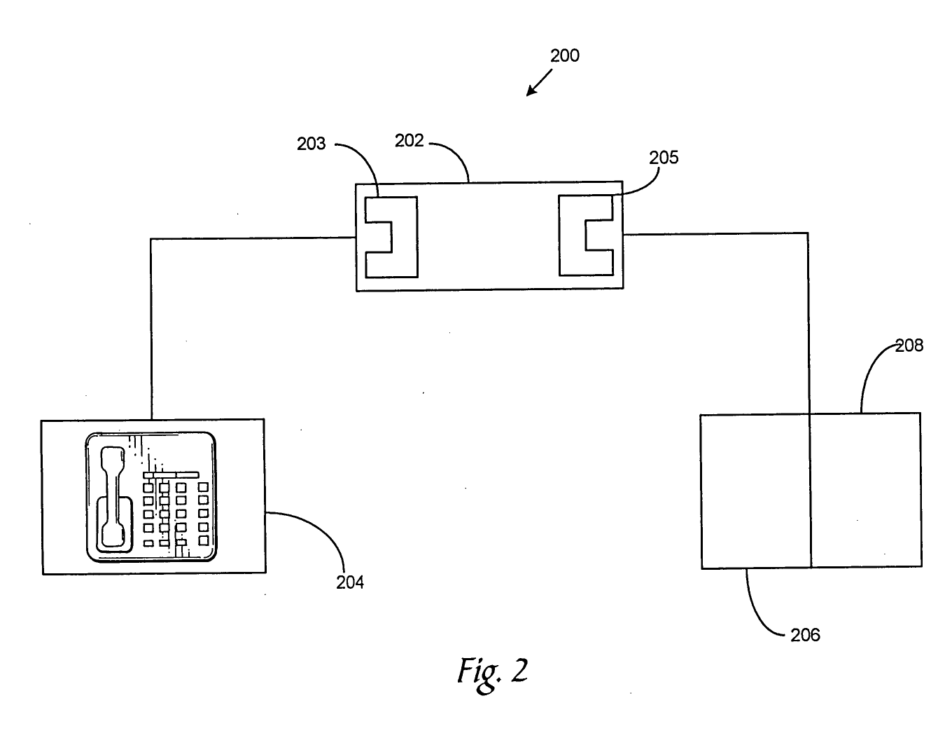

FIG. 2 illustrates an example phone converter 202 positionable in a network 200 for supplying a dial tone and/or power to a customer telephone system 204. A phone converter 202 may be a small device or circuitries configurable for those users that are converting from traditional time dimension multiplex (TDM) phone services to new services such as VoIP. The phone converter 202 may be in installed in the IDF, SAI or CO and therefore the users may not have to purchase devices to upgrade to the new service. The phone converter 202 may have the appropriate type of jacks, such as a power line output jack 203 in communication with a remote telephone system and which allows for the termination to the existing patch panel in the local telephone company system 106. An example jack 203 may include an RJ11 jack. The phone converter 202 includes a first interface 205 for termination to network equipment 206. An example first interface 205 may include an RJ45 jack. The phone converter 202 may utilize one of a number of wire pairs connected to the RJ45 jack to supply power to it. The power to the phone converter 202 is supplied by the CO 208, or the phone converter 202 may utilize commercial power. In the example embodiment, the CO 208 may be integrated with the network equipment 206 or may serve as a separate unit.

The phone converter 202 may provide a small form factor version. The phone converter 202 may be used on an individual case base, for example in an area where few customers are converting to VoIP at a time.

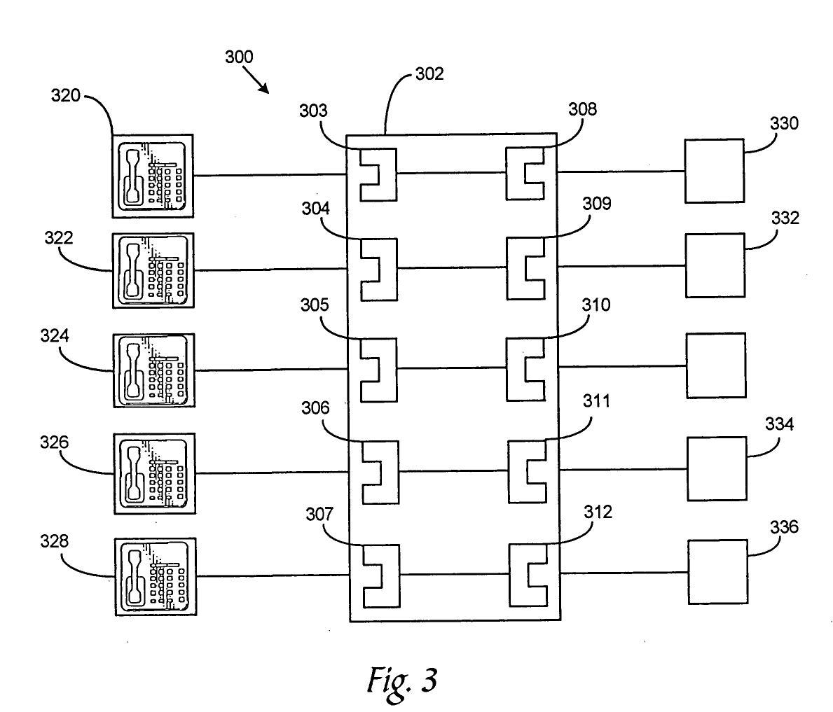

FIG. 3 illustrates an example network 300 including an example phone converter 302. The phone converter 302 may provide a larger form factor. The phone converter 302 may be used for a large area where many customers have or are converting to VoIP, for example a small business with few phones. The configuration on this phone converter 302 may be on a one on one basis so each cable pair connected to this device will requires its own cable pair out. In this embodiment, each power line output jack 303-307 is individually connected to a customer telephone system 320-328. Also in this embodiment, each first interface 308-312 is individually connected to each network equipment and/or CO 330-336. This configuration may make the troubleshooting of each individual phone easer.

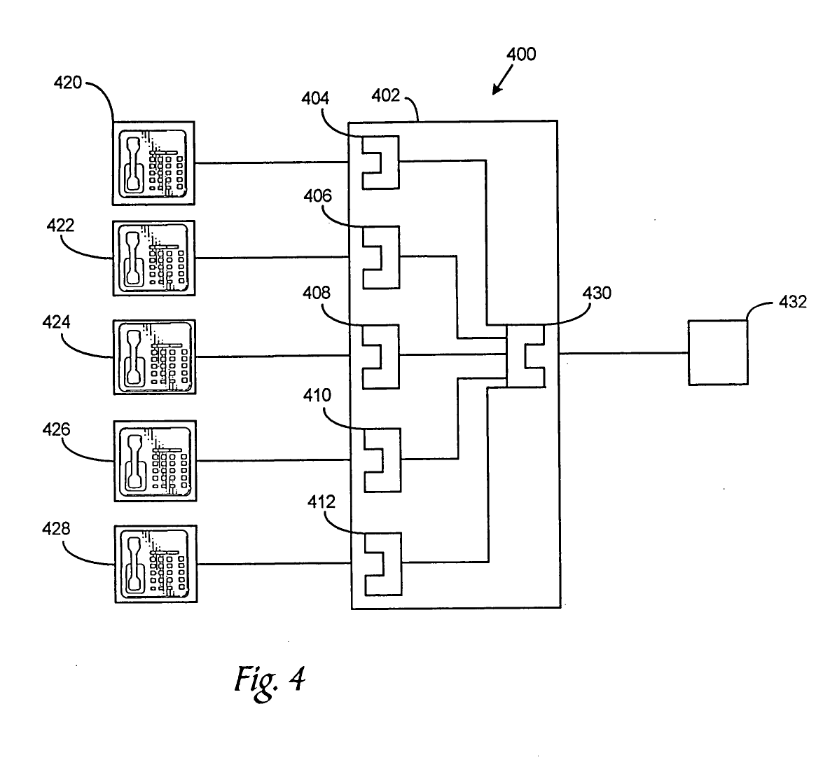

FIG. 3 illustrates an example network 400 including an example phone converter 402. FIG. 4 also depicts a larger size phone converter 402. This phone converter 402 is similar to the phone converter 302 illustrated in FIG. 3 device but it will require multiple separate cable pairs in and one connection out, therefore aggregating all the calls internally before passing to the network equipment 432. In this embodiment, each power line output jack 404-412 is individually connected to a customer telephone system 420-428. In this embodiment, a first interface 430 is connected to a network equipment/CO module 432. This phone converter 402 may be used for larger business or an area that has picked up on a VoIP and multiple users are converting to VoIP service.

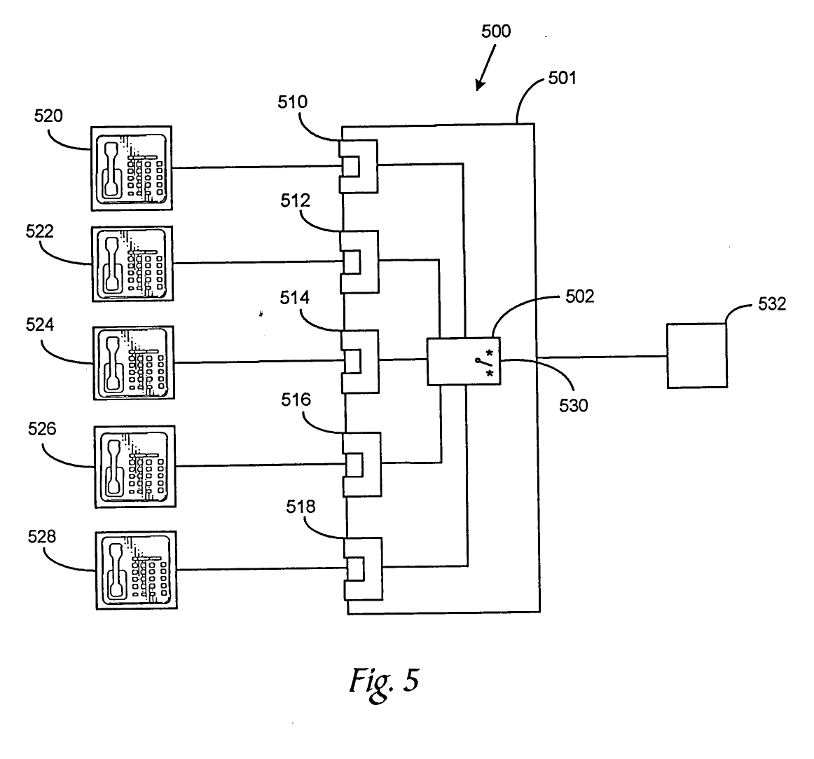

FIG. 5 illustrates a switching device 500 configurable to switch telephone calls. The switching device 500 includes a line card 501 configured to terminate switched telephone calls. The switching device 500 also includes a phone converter 502 configurable to supply power to a telephone system, such as a remote customer telephone system 520-528. The phone converter 502 is positionable on the line card 501. The switching device 500 includes one or more power line outputs 510-518 in communication with the line card 501, and a power line output in communication with a remote telephone system, and a first interface 530 for termination to a network equipment/CO module 532. The power line output may be an RJ-11 jack in one embodiment. The first interface 530 may be an RJ-45 jack in one embodiment. The line cards 501 may be installed in the switch and may be the card that calls are terminated on. Therefore, the manufacturer of the line card 501 may be required to build this circuitry within the product.

The phone converter 118 may remove the need for a phone customer to make changes or add additional components within their home, and still be able to move to new phone technology such as VoIP. The customer may need no additional customer premises equipment (CPE) such as an analog telephone adapter (ATA) or battery back-up equipment. For example, a phone company may calls a phone customer and ask them if they would like to move to the new voice plan that uses VoIP or other communications service. The customer would be required to make no changes to their home or phone equipment. The phone company would install a phone converter 118 at the local neighbor box (SAI or IDF) or in the Central Office (CO) and the new service will be active.

A customer could be connected to cable television or other sources for their entertainment services, while still using their old phone with a phone converter 118 enabled with the local Telco. This may allow the customer to have dial tone and 911 service no matter what happens to the power within the home. If a company that was supplying the customer's phone service also becomes the customer's entertainment provider, the phone converter 118 may become a port address on the network (or other line technology) making it possible for a single phone number and customer billing ID. No changes may be required to the entertainment source or in the customer's home for phone service.

The phone converter 118 is designed to be powered at the company's IDF, SAT and/or CO. The phone converter 118 may convert the customer's incoming phone line into a networked phone line or to other services without any in-home changes or battery backup required.

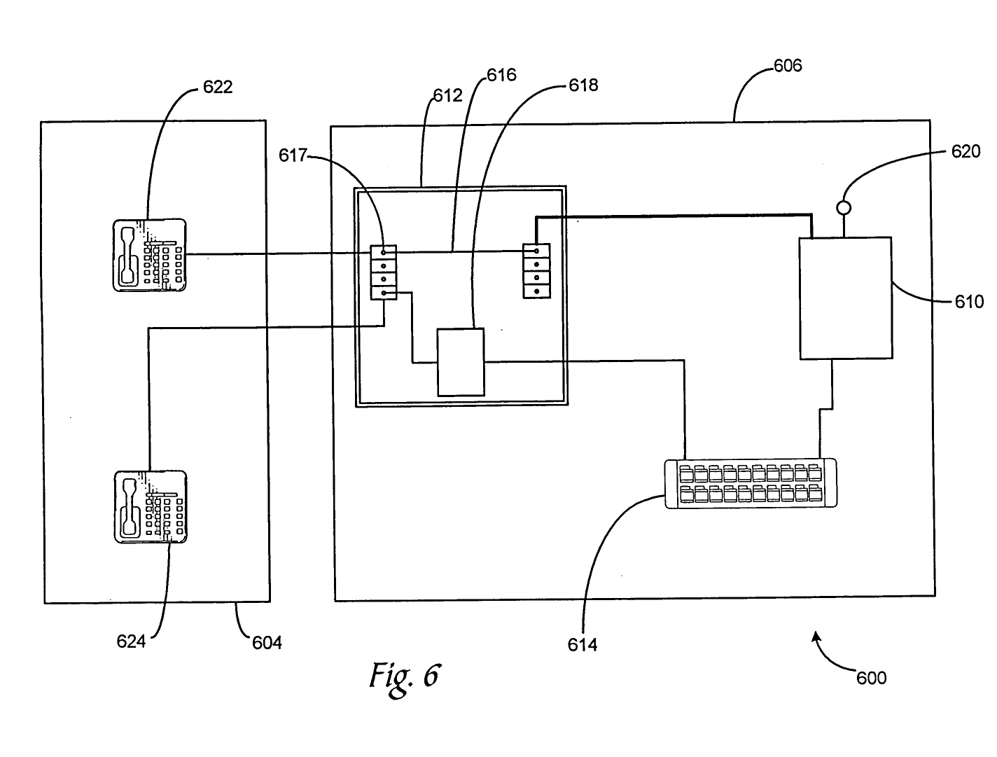

FIG. 6 illustrates a network 600 with a phone converter 618 positionable in the IDF/SAI 612 and interconnected with the network equipment 614 and the customer phones 604. The phone converter 618 includes a first interface with a patch panel 617, such as an RJ-11 jack, and a second interface configurable to interface with the network equipment 614, such as an RJ-45 jack. The phone converter 618 may receive power input from the CO 610. The CO 610 may receive power from a power source 620 such as a commercial power source, a generator, or a battery source.

POTS equipment may continue to be used in the field and the customer's home 622. The service may be upgraded to VoIP type services within the IDF/SAI utilizing the phone converter 618. FIG. 6 shows two standard phones 622 and 624 in service. A configurable phone 624 has a signal converter to work on the network starting at the IDF/SAI 612 and the other phone 622 may utilize the standard signaling and connections.

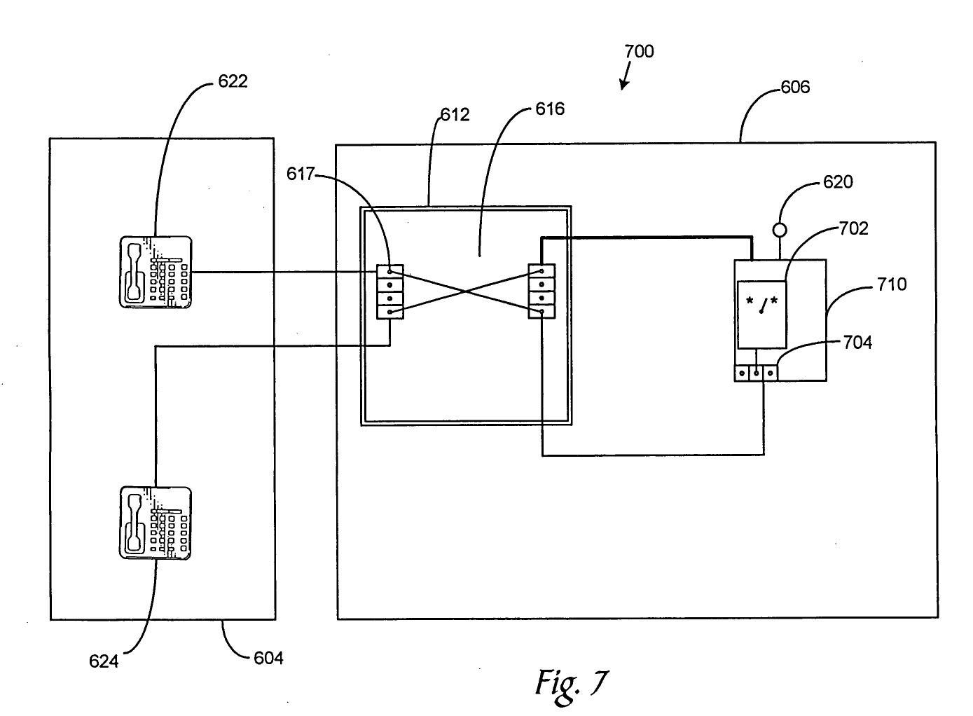

FIG. 7 illustrates a network 700 with a phone converter 702 that is installed in the CO 710. The phone converter 702 includes an interface to a patch panel 704 and an interface to a power source 720, such as a commercial power source, a generator, or a battery source. The network 700 may require no change of equipment or wiring in the field such as the IDF or SAI 612. The phone converter 702 may be installed in the CO 710 as a circuit board, and the customers wire pairs may be interconnected from its current position on the punch block in the CO 710 to the phone converter 702. The phone converter 702 may then be wired to the voice switch panel 704.

Code adapted to perform the functions of the phone converter 118, 202, 302, 618, or 702 may be encoded in a signal bearing medium, a computer readable medium such as a memory, programmed within a device such as one or more integrated circuits, or processed by a controller or a computer. If the methods are performed by software, the software may reside in a memory resident to or interfaced to the telephone network 100-700, a communication interface, or any other type of non-volatile or volatile memory interfaced or resident to the telephone network 100-700. The memory may include an ordered listing of executable instructions for implementing logical functions. A logical function may be implemented through digital circuitry, through source code, through analog circuitry, or through an analog source such as through an analog electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A device for supplying power to a telephone system comprising:
a phone converter positionable in a local telephone support unit,
a power line output in communication with the phone converter,
a power line output in communication with a remote telephone system, and
a first interface for termination to network equipment
where the phone converter is configured to interface with a patch panel located at a phone services distribution unit.

2. The device of claim 1 where the input power source is supplied from at least one of a central office (CO) power supply or a commercial power supply.

3. The device of claim 1 where the telephone support unit comprises an Intermediate Distribution Frame (IDF), a Serving Area Interface (SAI), or in a Central Office (CO).

4. The device of claim 1 where the power line input comprises an RJ45 jack, where the RJ45 jack comprises one or more wire pairs connected to the RJ45 jack.

5. The device of claim 4 where at least one of the wire pairs is configured to receive power.

6. The device of claim 1 further comprising a second interface configured to terminate to a patch panel.

7. The device of claim 6 where the second interface comprises an RJ11 jack.

8. The device of claim 1 where the first interface comprises one or more connections to a voice over internet protocol (VoIP) network.

9. The device of claim 1 where the remote telephone system lacks a connection to a plain old telephone service (POTS) connection.

10. A device for switching telephone calls comprising:
a line card configured to terminate switched telephone calls,
a phone converter configurable to supply power to a telephone system, where the phone converter is positionable on the line card,
a power line output in communication with the line card,
a power line output in communication with a remote telephone system, and
a first interface for termination to network equipment.

11. The device of claim 10 where the input power source is supplied from at least one of a central office (CO) power supply or a commercial power supply.

12. A device for switching telephone calls comprising:
a line card configurable to terminate switched telephone calls,
a converter means for supplying power to a telephone system, where the converter means is positionable on the line card,
a power line output from the line card in communication with a remote telephone system, and
a first interface for termination to network equipment.

13. The device of claim 10 where the telephone support unit comprises an Intermediate Distribution Frame (IDF), a Serving Area Interface (SAI), or in a Central Office (CO).

14. The device of claim 10 where the power line input comprises an RJ45 jack, where the RJ45 jack comprises one or more wire pairs connected to the RJ45 jack.

15. The device of claim 14 where at least one of the wire pairs is configured to receive power.

16. The device of claim 10 further comprising a second interface configured to terminate to a patch panel.

17. The device of claim 16 where the second interface comprises an RJ11 jack.

18. The device of claim 10 where the first interface comprises one or more connections to a voice over internet protocol (VoIP) network.

19. The device of claim 12 further comprising means for supplying a dial tone to the telephone system.

20. The device of claim 8 where the second interface is configurable to interface to more than one telephone system.

21. The device of claim 17 where the second interface is configurable to interface to more than one telephone system.
